(19) United States
(12) Patent Application Publication
(10) Pub. No.: US 2012/0105244 A1
(43) Pub. Date: May 3, 2012

(54) ELECTRONIC DEVICE AND OPERATION METHOD THEREOF

(75) Inventors: Lung-Hsun Song, Taipei City (TW); Li-Min Lee, Taipei City (TW)

(73) Assignee: INVENTEC CORPORATION, Taipei City (TW)

(21) Appl. No.: 13/013,776

(22) Filed: Jan. 25, 2011

(30) Foreign Application Priority Data
Oct. 28, 2010 (TW) 99137006

(51) Int. Cl. G08B 21/00; G09G 5/00; H04B 1/38

(52) U.S. Cl. 340/689; 455/566; 345/204

(57) ABSTRACT

An electronic device includes a main body, a display module, a storage module, an input module, and a control module all assembled to the main body. The storage module is used for storing a plurality of image files. The control module is electrically connected to the display module, the input module, and the storage module. When the display module displays the image files, the control module drives the display module to adjust a viewing direction of the image files according to a format data of the image files, which is an exchangeable image file format (EXIF), and adjusts an input mode of the input module according to an operation status of the main body. An electronic device and an operation method thereof are also provided.

### CROSS-REFERENCE TO RELATED APPLICATION

This application claims the priority benefit of Taiwan application serial no. 99137006, filed on Oct. 28, 2010. The entirety of the above-mentioned patent application is hereby incorporated by reference herein and made a part of this specification.

### BACKGROUND OF THE INVENTION

1. Field of the Invention

The invention relates to an electronic device and its operation method. More particularly, the invention relates to an electronic device and its operation method that can change the input module function according to the operation status.

2. Description of Related Art

Typical books are large and heavy; they are also bad for long-term storage. Therefore, a new type of reading method has emerged in the electronic book (eBook). Electronic books allow book content to be displayed page by page on the screens of electronic device platforms (i.e. computers, handheld PCs, PDAs, eBook reading devices). This type of reading method allows electronic books and electronic files to be saved in electronic device platforms for a long time. When users are outdoors, they can read by just bringing a handheld PC, PDA, or eBook reader with reading software.

Using eBook reading devices as an example, conventional eBook reading devices are differentiated by two general methods of use. One of the methods is a non-directional operation method. This method is used to simultaneously provide the different operating habits of right hand operations and left hand operations. With this, eBook reading devices usually have a left and right side configuration button (for example, a page flipping button or a direction button). As a result, the entire volume of an eBook reading device has to be increased. Furthermore, the operation button is disposed on the bottom of the eBook reading device screen. This inconveniences the reader and reduces the ease of reading.

The other method is to place the operation button on a side of the eBook reading device; this effectively reduces the eBook volume, but limits the device to just right hand or left hand users, not being suitable to all users.

### SUMMARY OF THE INVENTION

The invention is directed to an electronic device, suitable for users of different dominant hands.

The invention is also directed to an operation method of an electronic device. An input module of the electronic device changes its function based on the operation status of a main body, so that it is suitable for users of different dominant hands.

An electronic device including a main body, a display module, a storage module, an input module, and a control module all assembled to the main body is provided in an embodiment of the invention.

The storage module stores a plurality of image files The control module is electrically connected to the display module, the input module, and the storage module. When the display module displays the image files, the control module drives the display module to adjust a viewing direction of the image files according to a format data of each of the image files, which is an exchangeable image file format (EXIF), and the control module adjusts the input mode of the input module according to the operation status of the main body.

An operation method of an electronic device is provided in an embodiment of the invention. According to the operation method, driving the display module to adjust a viewing direction of the image files according to the format data of the image files. In addition, according to the operation status of the main body, driving the display module that the viewing direction of the image files is identical to the operation status of the main body. Then also driving the input module to change the input mode of the input module.

An electronic device comprises a main body, a display assembled to the main body, a processor assembled to the main body and electrically connected to the display, a memory assembled to the main body and electrically connected to the processor and storing a first command, a second command, and a plurality of image files, a first input unit and a second input unit assembled to the main body and electrically connected to the processor, and a gravity sensor module assembled to the main body and electrically connected to the processor. The first input unit invokes the first command and the second input unit invokes the second command in the memory when the gravity sensor module senses the main body being in a first operation status. The first input unit invokes the second command and the second input unit invokes the first command in the memory when the gravity sensor module senses the main body being in a second operation status.

According to an embodiment of the invention, the control module includes a processor and a gravity sensor. The processor determines the EXIFs and drives the display module to rotate the image files. The gravity sensor is electrically connected to the processor and senses the operation status of the main body.

According to an embodiment of the invention, when the gravity sensor senses a change in the main body from a first operation status to a second operation status, the processor drives the display module to rotate the image files from a first viewing direction to a second viewing direction. The processor also drives the input module to switch from a first input mode to a second input mode.

According to an embodiment of the invention, a direction of the first operation status and a direction of the second operation status differ substantially by 180 degrees, the first viewing direction and the second viewing direction differ substantially by 180 degrees, and a function of the first input mode and a function of the second input mode are opposite to each other.

According to an embodiment of the invention, the input module is substantially disposed on a directional unit beside a display surface of the display module. When the main body is in the first operation status, the directional unit has a position relative to the display surface, and when the main body is in the second operation status, the directional unit has another position relative to the display surface. The relative positions of the directional unit in the first operation status and the second operation status mirror each other.

According to an embodiment of the invention, the format data includes a pixel data and a direction data. In the operation method, reading the pixel data and the direction data, and comparing the pixel data and the direction data to the operation status of the main body. Then driving the display module to rotate the image files, such that the viewing direction of each of the image files is identical to the operation status of the main body.

According to an embodiment of the invention, the control module includes a processor and a gravity sensor electrically connected to each other. In the operation method, when the gravity sensor senses that the operation status of the main body is different from the viewing direction of the image files, driving the display module to rotate the image files.

According to an embodiment of the invention, when the main body changes from a first operation status to a second operation status, the processor drives the display module to rotate the image files from a first viewing direction to a second viewing direction. The processor also drives the input module to switch from a first input mode to a second input mode. The direction of the first operation status and the direction of the second operation status differ by 180 degrees, the first viewing direction and the second viewing direction differ by 180 degrees, and the function of the first input mode and the function of the second input mode are opposite to each other.

According to an embodiment of the invention, in the operation method, when the gravity sensor does not sense the operation status of the main body, driving the display module to a preset status to display the image files.

According to an embodiment of the invention, the first command and the second command are defined as two opposite switching directions of the image files driven by the processor separately.

According to an embodiment of the invention, when the gravity sensor module senses that the main body changes from the first operation status to the second operation status, the processor drives the display to rotate the image file from a first viewing direction to a second viewing direction.

According to an embodiment of the invention, a direction of the first operation status and a direction of the second operation status substantially differ by 180 degrees, the first viewing direction and the second viewing direction substantially differ by 180 degrees.

According to an embodiment of the invention, the first input unit and the second input unit are substantially directional units mirrored to each other.

Based on the above embodiments of the invention, the electronic device utilizes the control module to analyze the EXIF, so that the image files displayed on the display module conforms to the present operation status of the main body. Furthermore, the electronic device utilizes the gravity sensor to sense the operation status of the main body and switch functions of the input module, so that the electronic device is suitable for right hand users and left hand users, and the applicability of the electronic device is improved.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A through 1C are schematic diagrams illustrating an electronic device in different operation statuses according to an embodiment of the invention.

FIG. 2 is a block diagram of the related components in the electronic device depicted in FIGS. 1A through 1C.

FIG. 3 is a flowchart illustrating operation of the electronic device as depicted in FIG. 1.

### DESCRIPTION OF EMBODIMENTS

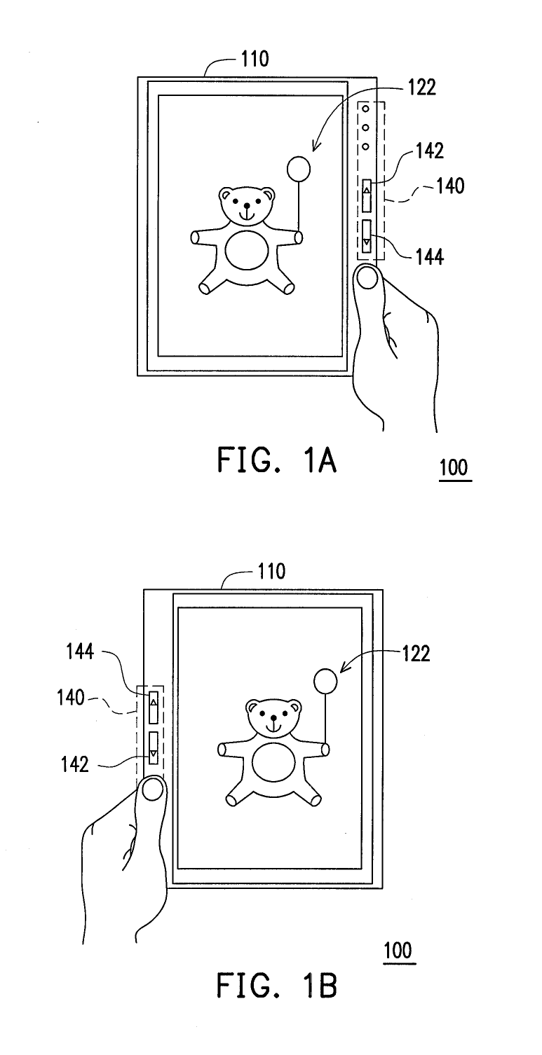

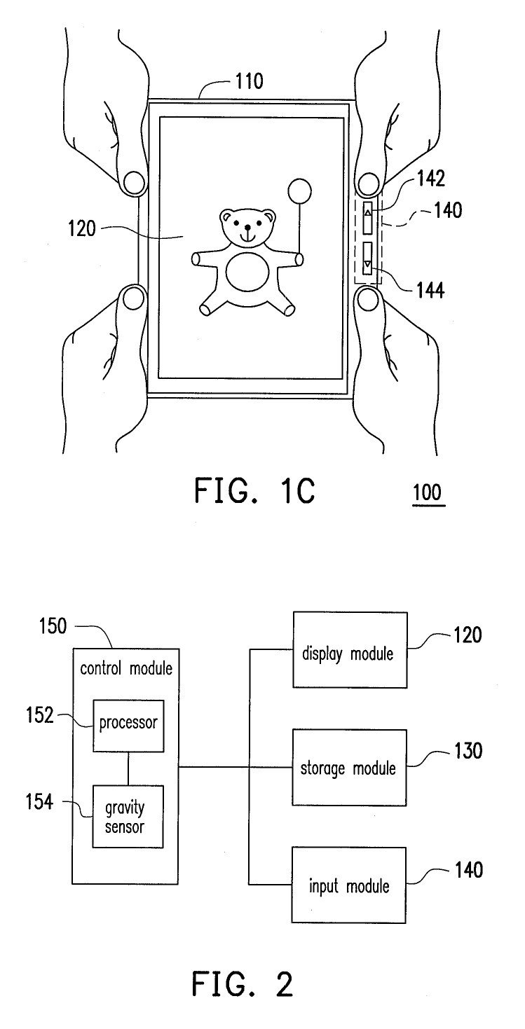

FIGS. 1A through 1C are schematic diagrams illustrating an electronic device in different operation statuses according to an embodiment of the invention. FIG. 2 is a block diagram of the related components in the electronic device depicted in FIGS. 1A through 1C. Please refer to FIGS. 1A through 2. In the embodiment, the electronic device 100, for example, is an eBook. In other embodiments of the invention, the electronic device can also be a mobile phone, a personal digital assistant (PDA), or other portable electronic devices. The electronic device 100 includes a main body 110, a display module 120, a storage module 130, an input module 140, and a control module 150 all assembled to the main body 110. The control module 150 is electrically connected to the display module 120, the storage module 130, and the input module 140. The storage module 130 is used for storing a plurality of image files.

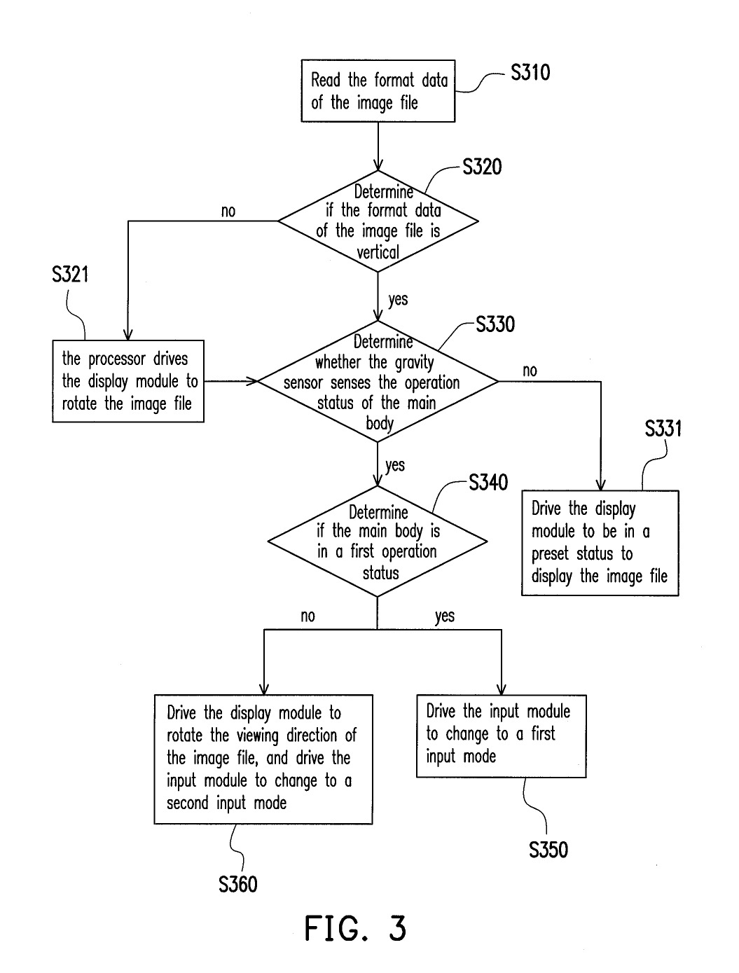

FIG. 3 is a flowchart illustrating operation of the electronic device as depicted in FIG. 1. Please refer to FIGS. 1A through 3. In the embodiment, the control module 150 includes a processor 152. The processor 152 is used for analyzing a format data of the image files, which is an exchangeable image file format (EXIF), and thereby the display module 120 can be driven to determine the viewing direction in which the image files is displayed.

In detail, each of the EXIFs includes a pixel data and a direction data. After analysis, the processor 152 can drive the display module 120 to display the image files vertically. For example, if the pixels of an image files are 600(w)×900(h), and the direction data column is null or normal, the image files is determined by the processor 152 as vertical. In this state, the processor 152 does not drive the display module 120 to make any adjustments towards the image files. On the other hand, if the pixels of another image files are 600×900, and the data direction column is “left”, the processor 152 drives the display module 120 to rotate 90 degrees, allowing the image files to be displayed vertically.

According to the operation method of this embodiment, in steps S310 and S320, the processor 152 reads the format data of the image file to determine if the image file is vertical. If not, the processor 150 drives the display module 120 to rotate the image file in step S320. Thereby, the processor 152 determines whether to rotate the image file or not, so as to make it conform to the preset viewing direction.

Furthermore, in this embodiment, the control module 150 further includes a gravity sensor 154 electrically connected to the processor 152. The gravity sensor 154 is used to determine the operation status of the main body 110. In addition, the main body 110 operates in a first operation status (shown in FIG. 1A), a second operation status (shown in FIG. 1B), or a third operation status (shown in 1C) based on users' choices. The main body 110 in the third operation status is, for example, oriented at a horizontal standstill, such that the user and people with the user can read data on the electronic device 100 together. Thus, in step S330, the processor 152 determines whether the gravity sensor 154 senses the operation status of the main body 110. When the gravity sensor 154 does not sense the operation status of the main body 110, the processor 152 determines the main body be in the third operation status, and the processor 152 then drives the display module 120 to be in a preset status to display the image files in step S331. The embodiment does not limit the display module 120 to any particular preset status to display the image files. The preset status can be determined based on users' preference.

Next, when the main body 110 of the electronic device 100 is switched from the first operation status shown in FIG. 1A to the second operation status shown in FIG. 1B, the processor 152, based on the sensing result of the gravity sensor 154, drives the display module 120 to rotate the image files, such that the viewing direction of the image files conforms to each operation status of the main body 110.

For example, in step S340, the processor 152, based on the sensing result of the gravity sensor 154, determines if the main body 110 is in a right hand operation status (the first operation status as drawn in FIG. 1A). If so, then in step S350, the processor 152 drives the display module 120, so that the viewing direction of the image files is identical to the first operation status of the main body 110. More importantly, the processor 152 further drives the input module 140 to change to a first input mode. On the contrary, in the step S360, if the main body 110 is not in the right hand operation status, it means the main body 110 is in the second operation status, which is different from the first operation status by 180 degrees, as shown in FIG. 1B. At this point, the processor 152 drives the display module 120 to rotate the viewing direction of the image files by 180 degrees, and drives the input module 140 to change to a second input mode.

In the embodiment, the input module 140 is a directional unit beside a display surface 122 of the display module 120 substantially, and the directional unit is, for example, a direction button or a roller. When the main body 110 is respectively in the first operation status and the second operation status, the position of the input module 140 mirrors the position of the display surface 122. Accordingly, the difference between the first input mode and the second input mode of the input module 140 lies in that a button 142 and a button 144 are respectively set by the processor 152 to have page up and page down functions when the first input module 140 is in the first input mode. When the input module 140 is in the second input mode, the processor 152 respectively sets the button 142 and the button 144 to have page down and page up functions. The functions of the input module 140 in the second input mode are exactly opposite to those of the input module 140 in the first input mode. With this process, the button 142 and the button 144 conform to the operation status of the main body 110. In other words, the storage module 130, for example, is a memory assembled to the main body 110, electrically connected to the processor 152, and storing a plurality of image files described above. The input module 140 in the present embodiment includes a first input unit (button 140) and a second input unit (button 142). Besides, a first command and a second command are stored in the memory, wherein the first command and the second command are defined as two opposite switching directions of the image files driven by the processor separately. For example, when the input module 140 is in the first input mode, the first input unit (button 140) invokes the first command and the second input unit (button 142) invokes the second command in the memory, wherein the first command is defined as page-up function and the second command is defined as page-down function. Contrarily, the first input unit (button 140) invokes the second command (page-down function) and the second input unit (button 140) invokes the first command (page-up function) when the input module 140 is in the second input mode.

The embodiment illustrates but poses no limitation on how the functions of the input module 140 are changed according to the operation status of the main body 110. According to another undrawn embodiment, the input module can also assemble a touch module to the display module. As the operation method of the main body changes, the similar operating gestures in the touch module also change accordingly. As such, the electronic device can satisfy the needs of both right hand and left hand users.

To sum up, in the embodiments of the invention, the electronic device utilizes the control module to analyze the EXIF, so that the image files displayed on the display module conforms to the present operation status of the main body. Furthermore, the electronic device utilizes the gravity sensor to sense the operation status of the main body and switch the functions of the input module, so that the electronic device is suitable for both right hand users and left hand users, increasing the applicability of the electronic device.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An electronic device comprising:
a main body;
a display module assembled to the main body;
a storage module assembled to the main body and storing a plurality of image files;
an input module assembled to the main body; and
a control module assembled to the main body and electrically connected to the display module, the input module, and the storage module, wherein when the display module displays each of the image files, the control module drives the display module to adjust a viewing direction of each of the image files according to a format data of each of the image files, and the control module adjusts an input mode of the input module according to an operation status of the main body.

2. The electronic device of claim 1, wherein the control module comprises:
a processor for determining the format data of each of the images files and driving the display module to adjust the image files; and
a gravity sensor electrically connected to the processor, the gravity sensor sensing the operation status of the main body.

3. The electronic device of claim 2, wherein when the gravity sensor senses in the main body a change from a first operation status to a second operation status, the processor drives the display module to rotate the image file from a first viewing direction to a second viewing direction, and the processor drives the input module to switch from a first input mode to a second input mode.

4. The electronic device of claim 3, wherein a direction of the first operation status and a direction of the second operation status substantially differ by 180 degrees, the first viewing direction and the second viewing direction substantially differ by 180 degrees, and a function of the first input mode and a function of the second input mode are opposite to each other.

5. The electronic device of claim 4, wherein the input module is substantially a directional unit disposed beside a display surface of the display module, when the main body is in the first operation status, the directional unit has a position relative to the display surface, when the main body is in the second operation status, the directional unit has another position relative to the display surface, and the relative positions of the directional unit in the first operation status and the second operation status mirror each other.

6. A method for operating the electronic device of claim 1, the method comprising:
according to the format data of each of the image files, driving the display module to adjust the viewing direction of each of the image files; and
according to the operation status of the main body, driving the display module, such that the viewing direction of the image file and the operation status of the main body are identical, and the control module drives the input module to change the input mode of the input module.

7. The method of claim 6, wherein the format data, being an exchangeable image file format (EXIF), includes a pixel data and a direction data, and the operation method further comprising:
Reading the pixel data and the direction data, so as to compare the pixel data and the direction data with the operation status of the main body; and
Driving the display module to rotate the image files, such that the viewing direction of each of the image files are identical to the operation status of the main body.

8. The method of claim 7, wherein the control module includes a processor and a gravity sensor electrically connected to each other, and the method further comprises:
when the gravity sensor senses that the operation status of the main body is different from the viewing direction of the image file, driving the display module to rotate the image file.

9. The method of claim 8, wherein when the main body changes from a first operation status to a second operation status, driving the display module to rotate the image file from a first viewing direction to a second viewing direction, and driving the input module to switch from a first input mode to a second input mode, a direction of the first operation status and a direction of the second operation status differ by 180 degrees, the first viewing direction and the second viewing direction differ by 180 degrees, and a function of the first input mode and a function of the second input mode are opposite to each other.

10. The method of claim 8, further comprising:
when the gravity sensor does not sense the operation status of the main body, driving the display module to be in a preset status to display the image files.

11. An electronic device comprising:
a main body;
a display, assembled to the main body;
a processor, assembled to the main body and electrically connected to the display;
a memory, assembled to the main body, electrically connected to the processor, and storing a first command, a second command, and a plurality of image files;
a first input unit and a second input unit, assembled to the main body and electrically connected to the processor; and
a gravity sensor module, assembled to the main body and electrically connected to the processor, the first input unit invokes the first command and the second input unit invokes the second command in the memory when the gravity sensor module senses the main body being in a first operation status, the first input unit invokes the second command and the second input unit invokes the first command in the memory when the gravity sensor module senses the main body being in a second operation status.

12. The electronic device of claim 11, wherein the first command and the second command are defined as two opposite switching directions of the image files driven by the processor separately.

13. The electronic device of claim 11, when the gravity sensor module senses that the main body changes from the first operation status to the second operation status, the processor drives the display to rotate the image file from a first viewing direction to a second viewing direction.

14. The electronic device of claim 13, wherein a direction of the first operation status and a direction of the second operation status substantially differ by 180 degrees, the first viewing direction and the second viewing direction substantially differ by 180 degrees.

15. The electronic device of claim 14, wherein the first input unit and the second input unit are substantially directional units mirrored to each other.
